(19) United States
(12) Patent Application Publication
(10) Pub. No.: US 2003/0136194 A1
(43) Pub. Date: Jul. 24, 2003

(54) Acoustic particulates density meter

(76) Inventors: Sean F. Wu, Troy, MI (US); Ravinder S. Beniwal, Detroit, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/308,868

(22) Filed: Dec. 2, 2002

Related U.S. Application Data
(60) Provisional application No. 60/338,409, filed on Dec. 5, 2001.

(51) Int. Cl. G01N 29/04

(52) U.S. Cl. 73/597

(57) ABSTRACT

A technique for determining particulate density in a fluid monitors the changes in the speed of sound. Since the speed of sound is intimately related to the composites of the air mixture and since the speed of sound of clean air at any temperature and humidity can be calculated exactly, it is possible to estimate the density of any foreign particulates in the air by observing changes in the speed of sound. Formulations are derived that correlate the change in the speed of sound of the air mixture to their density fluctuations, thus allowing people to estimate the mass density of foreign particulates under any temperature and humidity

### RELATED APPLICATIONS

This application claims priority to U.S. Provisional Serial No. 60/338,409 filed Dec. 5, 2001.

### BACKGROUND OF THE INVENTION

This invention provides a cost-effective methodology to measure the mass concentration of impurities in the air resulting from the exhaust of a combustion system such as diesel and gasoline engines used in the automotive industry. This methodology can also be used to measure any particulates in gas streams used in industry. It is drastically different from the conventional methods that are currently used by the automotive companies in monitoring particulates emissions.

Test data have shown that the average sizes of particulates from the exhaust of combustion systems are in the order of nanometers, or 10⁻⁹ meter, which are invisible but can be harmful when inhaled. The Environmental Protection Agency (EPA) has established strict regulations on the level of mass concentration of particulates discharged from the exhaust of combustion systems in order to reduce air pollution. The allowable level of particulates decreases every year as the demand on pollution control increases.

The conventional way of measuring the level of particulates concentration is to use a special filter to collect the residuals of the exhaust gases through a diluted chamber over certain period of time, and then weigh them on an electronic micro-scale inside a clean room. The equipment and facilities involved can be extremely expensive and the whole process can be very time consuming.

### SUMMARY OF THE INVENTION

The present invention monitors the changes in the speed of sound in the exhaust gases. Since the speed of sound is intimately related to the composites of the air mixture and since the speed of sound of clean air at any temperature and humidity can be calculated exactly, it is possible to estimate the density of any foreign particulates in the air by observing changes in the speed of sound. Formulations are derived that correlate the change in the speed of sound of the air mixture to their density fluctuations, thus allowing people to estimate the mass density of foreign particulates under any temperature and humidity. This new technique may include a function generator, power amplifier, speaker, humidity meter, thermometer, microphones, oscilloscope, and personal computer that are readily available in the market.

This new method is much simpler, more efficient and convenient, and costs much less than the existing technologies. Moreover, tests can be carried out on site and results can be printed out immediately.

Preliminary experiments have demonstrated that this technique is quite robust and sensitive. It can detect tiny little changes in the density fluctuations of airflow due to the presence of trace of smoke. The disadvantage of this new technique is that it cannot estimate the sizes of these foreign particulates. Rather, it yields an overall concentration level of particulates. On the other hand, the conventional methodology described above cannot measure the sizes of the particulates either.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic of the acoustic particulates density meter of the present invention in use measuring particulates density from a vehicle exhaust.

### DETAILED DESCRIPTION OF A PREFERRED EMBODIMENT

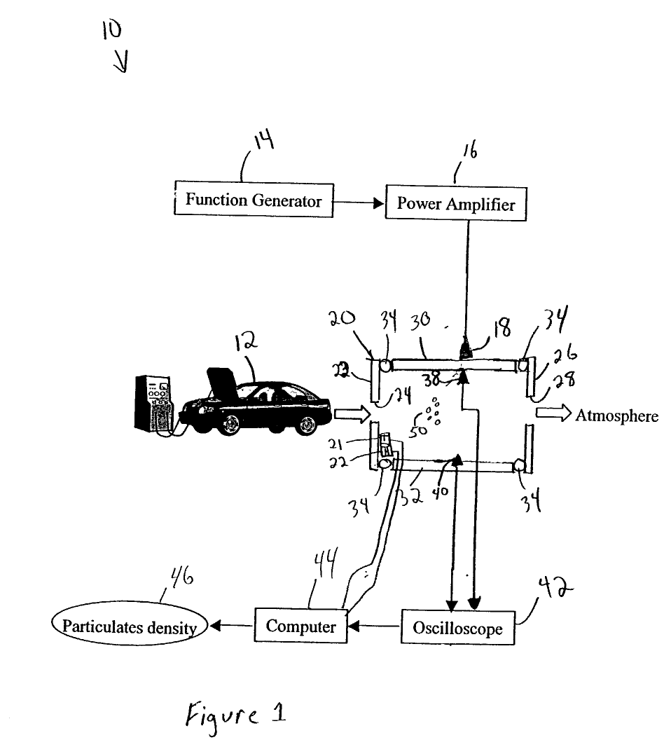

FIG. 1 schematically illustrates the acoustic particulates density meter 10 of the present invention in one potential use in measuring the particulate density of exhaust from a vehicle 12. The meter 10 includes a function generator 14 which sends out an impulse that is amplified by a power amplifier 16. This impulse is emitted through a loudspeaker 18 and impinges on a tube 20. An exhaust system of the vehicle 12 discharges a gas mixture through the tube 20 to atmosphere. A thermometer 21 and a humidity meter 22 measure the temperature and relative humidity of the airflow inside tube 20.

The tube 20 comprises a forward wall 22 having an opening 24 for receiving the exhaust gases and an opposing rearward wall 26 having an opening 28 for discharging the exhaust gases to atmosphere. The tube 20 further includes sidewalls 30 and 32 enclosing the tube 20 and connecting forward wall 22 to rearward wall 24. Foam 34 is disposed between the sidewalls 30, 32 and the forward and rearward walls 22, 26 to damp any vibration and prevent sound from being transmitted through the structure of the tube 20.

The impulse thus generated is measured by a microphone 38 on the same sidewall 30 as the speaker 18 and a microphone 40 mounted on the opposite sidewall 32. Signals from both microphones are received and displayed by an oscilloscope 42. The oscilloscope 42 sends these signals to a computer 44, which compares the arrival times of two signals to determine the time required for the signal to cross the tube 20. Since the distance across the tube 20 is fixed, the speed of sound through any gas mixture can be calculated. Note that calibrations must be done to determine the time required for the signal to travel across the tube 20 through pure air (i.e. without particulates). The microphone 38 can be used to cancel out ambient noise. The computer 44 calculates the mass density of particulates 50 of the gas mixture and results are printed out at 46.

The formulations that correlate the changes in sound speeds to the density of the particulates dₚₐᵣ in the airflow are given by

$${d}_{par} = ( \frac{{W}_{av} - {W}_{par}}{{W}_{av} - {W}_{con}} ) ( \frac{{W}_{con}}{V} ) , \qquad ( 1 )$$

where V is the molar volume of the air mixture, Wₐᵥ, Wₚₐᵣ, and W_{com} represent the average molecular weights of the wet air, gas mixture containing particulates, and constituents of particulates, respectively,

Wₐᵥ=(1+α_{wet})Wₐᵢᵣ, (2)

Wₚₐᵣ=(1+αₚₐᵣ)Wₐᵥ, (3)

W_{com}=(molecular weight of constituents of particulate), (4)

$$V = \frac{( 273.16 + T ) \times 22.4 \times 0.001}{273.16} , \qquad ( 5 )$$

where T is the temperature in Celsius, Wₐᵢᵣ=29 is the average molecular weight of air, and the quantities α_{wet} and αₚₐᵣ can be expressed, respectively, as

$$\begin{matrix}{α}_{wet} = ( \frac{{γ}_{wet}}{{γ}_{dry}} ) {( \frac{331 + 0.61 T}{{C}_{wet}} )}^{2} - 1 , & ( 6 ) \\ {α}_{par} = {( \frac{{C}_{wet}}{{C}_{meas}} )}^{2} - 1 , & ( 7 )\end{matrix}$$

where γ_{dry} and γ_{wet} are the specific heat ratios of dry air and wet air, respectively,

γ_{dry}=1.4, (8)

$${γ}_{wet} = \frac{7 + {M}_{wet}}{5 + {M}_{wet}} . \qquad ( 9 )$$

and C_{wet} and Cₘₑₐₛ in Eqs. (6) and (7) are the sound speed of the humid air and the measured speed of sound, respectively,

$$\begin{matrix}{C}_{wet} = ( 331 + 0.61 T ) \times [ 1 + \frac{0.16 \times P ( T )}{10132500} ] , & ( 10 ) \\ {C}_{meas} = \frac{0.235 \times {10}^{6}}{( t - 198 )} , & ( 11 )\end{matrix}$$

where t is the measured time. The quantity M_{wet} in Eq. (9) is the mole fraction of water in the air and is given by,

$${M}_{wet} = \frac{h \times P ( T )}{10132500} , \qquad ( 12 )$$

where h is the relative humidity in the air and P(T) is the saturated pressure that can be written as a function of temperature T as

P(T)=10⁶×e^{F(T)}, (13)

where the exponent F(T) is given by

$$F ( T ) = 10.459 - 4.04897 \times {10}^{- 3} T - 4.1752 \times {10}^{- 5} {T}^{2} + 3.6851 \times {10}^{- 7} {T}^{3} - 1.0152 \times {10}^{- 9} {T}^{4} + 8.6531 \times {10}^{- 13} {T}^{5} + 9.03668 \times {10}^{- 16} {T}^{6} - 1.9969 \times {10}^{- 18} {T}^{7} + 7.79287 \times {10}^{- 22} {T}^{8} + 1.91482 \times {10}^{- 25} {T}^{9} - 3968.06 / ( T - 39.5735 ) \qquad ( 14 )$$

The above formulations indicate that given the average molecular weight of constituents of particulates M_{con}, temperature T, relative humidity h, and measured time t, the density of particulates in any airflow can be calculated. In many cases, however, the exact value of M_{con} is unknown. Nevertheless, for most gas mixtures resulting from combustion it is appropriate to assume that the major constituent of the air mixture is carbon. Hence set M_{con}=12 if nothing is specified.

As an example, these formulations were tested on incense and let only a trace of smoke flowing through a tube. The temperature and humidity were 24.8° C. and 46.8, respectively. The major component of constituent of particulates in this case was assumed to be carbon and therefore M_{con}=12. The measured time for the impulse to travel from the loudspeaker to microphone was t=875.0 μs. Based on these input data, saturated pressure P(T)=3136.42 Pa, the mole fraction of water M_{wet}=0.01449, the specific heat ratio for wet air γ_{wet}=1.398844427, the sound speed of the humid air C_{wet}=346.93 m/s, measured speed of sound Cₘₑₐₛ=347.12 m/s, α_{wet}=−0.005441211, αₚₐᵣ=−0.001090829, the molar volume of the air mixture V=0.02443368, the average molecular weight of the wet air Wₐᵥ=28.84220488, and average molecular weight of the gas mixture containing particulates Wₚₐᵣ=28.81074297. Substituting these values into Eq. (1), the mass density of the carbon due to the presence of a trace of incense smoke was found to be dₚₐᵣ=0.9174 g/m³.

Suppose that all conditions remain the same, but the amount of smoke is increased so that the measured time is reduced to t=874.999 μs, namely, a mere 10⁻⁹ s difference. The resulting density of particulates would be dₚₐᵣ=0.920 g/m³. Consequently, these formulations are sensitive enough to detect changes of 0.002 g/m³ or 2 mg/m³.

Moreover, since these formulations are valid for instant changes in temperature, relative humidity, speed of sound of gas mixture, etc., they can be used to monitor the level of mass density of foreign particulates resulting from combustion or other means on site and produce results instantly. The system is calibrated to temperature and humidity with a calibration curve in the computer 44. Although the system is shown with the exhaust gases and particulates 50 continuously passing through tube 20 via openings 24 and 28, it is also possible to simply capture a sample of the gas within the tube 20 for testing as described above, which may be more convenient in some applications. The term “tube” is used herein in its broadest sense, to include any shape structure which is at least partially enclosed.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers for steps in the method claims are for ease of reference by dependent claims, and do not indicate a required sequence, unless otherwise indicated.

What is claimed is:

1. A method for measuring particulates density in a fluid including the step of measuring change in the speed of a wave through the fluid.

2. The method of claim 1 further including the step of generating the wave at one end of an enclosure.

3. The method of claim 2 further including the step of sensing the wave at an opposite end opposite the one end of the enclosure.

4. The method of claim 3 further including the step of measuring a time for the wave to travel through the fluid from the one end to the opposite end of the enclosure.

5. The method of claim 4 further including the step of sensing the wave at the one end.

6. The method of claim 5 further including the step of comparing the wave sensed at the one end to the wave sensed at the opposite end to determine the time of travel.

7. The method of claim 6 wherein the formulations that correlate the changes in sound speeds to the density of the particulates dₚₐᵣ in the fluid are given by
$${d}_{par} = ( \frac{{W}_{av} - {W}_{par}}{{W}_{av} - {W}_{con}} ) ( \frac{{W}_{con}}{V} ) ,$$
where V is the molar volume of the air mixture, Wₐᵥ, Wₚₐᵣ, and W_{com} represent the average molecular weights of the wet air, gas mixture containing particulates, and constituents of particulates, respectively.

8. The method of claim 6 further including the step of vibrationally isolating the one end of the enclosure from the opposite end of the enclosure.

9. The method of claim 1 wherein the formulations that correlate the changes in sound speeds to the density of the particulates dₚₐᵣ in the fluid are given by
$${d}_{par} = ( \frac{{W}_{av} - {W}_{par}}{{W}_{av} - {W}_{con}} ) ( \frac{{W}_{con}}{V} ) ,$$
where V is the molar volume of the air mixture, Wₐᵥ, Wₚₐᵣ, and W_{com} represent the average molecular weights of the wet air, gas mixture containing particulates, and constituents of particulates, respectively.

10. An acoustic particulates density meter comprising:
an at least partially enclosed container;
a first transducer for generating a wave into the container;
a second transducer for sensing the wave in the container;
a computer for analyzing a time of travel of the wave in the container to determine a particulate density of a fluid in the container.

11. The acoustic particulates density meter of claim 10 further including a third transducer adjacent the first transducer, the computer determining the time of travel of the wave from the third transducer to the second transducer.

12. The acoustic particulates density meter of claim 11 wherein the wave is a sound wave.

13. The acoustic particulates density meter of claim 12 wherein the wave is an impulse.

14. The acoustic particulates density meter further of claim 13 wherein the first transducer is a loudspeaker.

15. The acoustic particulates density meter of claim 14 wherein the second and third transducers are microphones.

16. The acoustic particulates density meter of claim 10 wherein the second transducer is vibrationally isolated from the first transducer.

17. The acoustic particulates density meter 16 wherein the first transducer is mounted to a first sidewall of the tube and the second transducer is mounted to an opposite sidewall of the tube, the opposite sidewall of the tube being vibrationally insulated from the first sidewall.
